(19) United States
(12) Patent Application Publication
(10) Pub. No.: US 2007/0150102 A1
(43) Pub. Date: Jun. 28, 2007

(54) Method of supporting robot application programming and programming tool for the same

(76) Inventors: Joong Ki Park, Daejeon-city (KR); Joong Bae Kim, Daejeon-city (KR); Woo Young Kwon, Seongnam-city (KR); Kyeong Ho Lee, Daejeon-city (KR); Young Jo Cho, Seongnam-city (KR)

Correspondence Address: LADAS & PARRY LLP, 224 SOUTH MICHIGAN AVENUE, SUITE 1600, CHICAGO, IL, 60604, US

(21) Appl. No.: 11/635,222

(22) Filed: Dec. 7, 2006

(30) Foreign Application Priority Data
Dec. 9, 2005 (KR) 10-2005-0121047
Oct. 9, 2006 (KR) 10-2006-0098097

(51) Int. Cl. G06F 19/00

(52) U.S. Cl. 700/245

(57) ABSTRACT

A method of supporting robot application programming and a programming tool for the same are provided. In the method of supporting robot application programming, behaviors that constitute operations to be performed by a robot are assembled in the programming tool for programming an application program for the operations to be performed by the robot. The method includes: (a) classifying the operations to be performed by the robot by functions of the robot; (b) displaying the behavior of the robot which can constitute one of the functions on a display device in a graphical form with block shapes that can be connected one another visually with a plurality of conditions; and (c) converting a set of the blocks into an XML file, when the function of the robot is constructed as a robot task by the set of blocks in the graphical form. Accordingly, various robot applications can be intuitively, easily and speedily developed by simply manipulating the tool boxes of the graphical programming tools without directly inputting code in text form.

### CROSS-REFERENCE TO RELATED PATENT APPLICATION

This application claims the benefits of Korean Patent Application No. 10-2005-0121047, filed on Dec. 9, 2005, and Korean Patent Application No. 10-2006-0098097, filed on Oct. 9, 2006, in the Korean Intellectual Property Office, the disclosures of which are incorporated herein in their entirety by reference.

### BACKGROUND OF THE INVENTION

1. Field of the Invention

The present invention relates to a method of visually preparing an application control program for controlling a robot, and a programming tool for the same, and more particularly, to a method of preparing a robot control program which is represented by an assembly of robot action blocks visualized by diagrams instead of text, and a programming tool for the same.

2. Description of the Related Art

In the past, to control a robot, a programmer had to code entire modules at a code level, even for common functions such as robot action, speech recognition, and graphical user interface (GUI). Since the modules had to be recompiled whenever they were changed, maintained, or repaired, robot programming was expensive, time consuming, and needed specialized knowledge.

Currently used methods of preparing robot tasks employ one of the following two types of method.

In the first method, a robot task program is directly prepared by using an object oriented language such as C++ or java or C language by using an interface which represents the hardware. This method has the disadvantage that developers have difficulty preparing a task if they are not skilled in robot hardware features and control programs. In addition, it is difficult to change the attributes of the once prepared robot task during an execution time.

In the second method, data dependent on the hardware used for the robot task is prepared by using XML, thereby adding flexibility to the programming. In this method, since information on features of the hardware used by the robot task is written in XML, the execution time can be reduced, and the robot task can be easily changed. However, as mentioned in the first method, only those skilled in robot programming can develop robot tasks, since the robot tasks are also developed using a programming language.

Because of these technical limits, it is impossible to satisfy the need for developing a large amount of contents for robots and robot application programs in which systematic information is effectively transmitted to the end user by utilizing various robot resources in order to commercialize the robot.

A multimedia authoring tool for real time lectures has also been developed. This authoring program downloads multimedia content from a server in real time to a personal computer, and reproduces data such as general objects, sound, and moving pictures through a separate player. However, since this tool was developed for remote lecture objects, it cannot be used to prepare contents for robots including the various robot actions.

Moreover, since the previously developed robot control program has to be coded as text in a high level programming language, it is difficult for developers to use if they are not skilled in that field.

### SUMMARY OF THE INVENTION

The present invention provides a method of supporting robot application programming and a programming tool for the same, which allows a robot program to be easily developed by a general robot user instead of a professional programmer by combining motion, speech recognition, speech synthesis, GUI, and other application modules such as mail send, music play, and sound play.

According to an aspect of the present invention, there is provided a method of supporting robot application programming in which behavior that constitutes operations to be performed by a robot are assembled in a programming tool for programming an application program for the operations to be performed by the robot, the method including: classifying the operations to be performed by the robot by functions of the robot; displaying the behavior of the robot which can constitute one of the functions of the robot on a display device in a graphical form with block shapes that can be connected one another visually with a plurality of conditions; and converting a set of the blocks into an XML file, when the function of the robot is constructed as a robot task by the set of blocks in the graphical form.

According to another aspect of the present invention, there is provided a programming tool for a robot application program, the programming tool including: an action window which displays an action block obtained by visualizing one or more behaviors to be performed by a robot; a selection window in which the behavior of the action block is displayed and the selected behavior is input into the action block; and a toolbar window which includes shortcuts related to a pallet menu that can open or close, storing/opening, uploading to the robot, and executing operations, and supplies tools for completing execution of the action block.

### BRIEF DESCRIPTION OF THE DRAWINGS

The above and other features and advantages of the present invention will become more apparent by describing in detail exemplary embodiments thereof with reference to the attached drawings in which:

FIG. 1 is a flowchart illustrating a method of supporting robot application programming according to an embodiment of the present invention;

FIG. 2 illustrates a window of a programming tool for a robot application program according to an embodiment of the present invention;

FIG. 3 illustrates an example of a task description which can be prepared on the basis on an XML schema;

FIGS. 4 to 7 illustrates tasks in FIG. 2 in detail; and

FIG. 8 illustrates two set values when the execution type of a task is a timer.

### DETAILED DESCRIPTION OF THE INVENTION

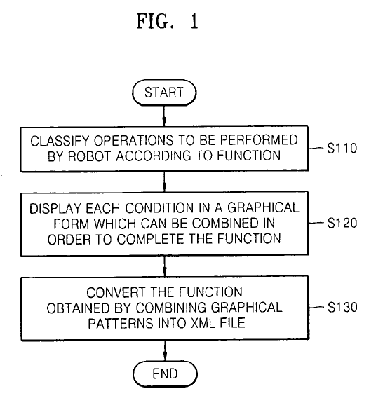

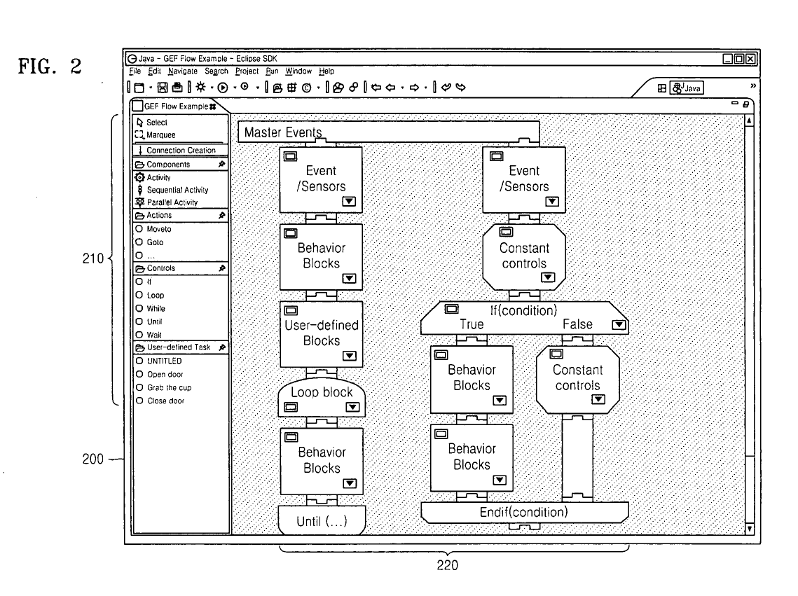

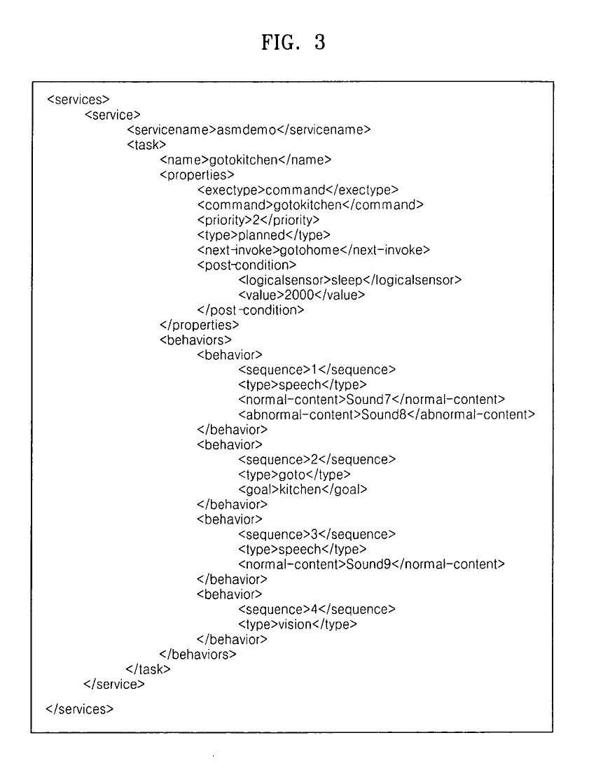

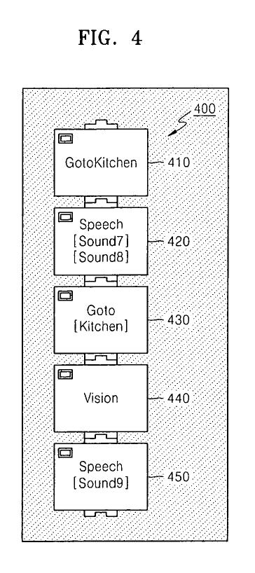

Preferred embodiments of the present invention will now be described in detail with reference to the attached drawings. FIG. 1 is a flowchart illustrating a method of supporting robot application programming according to an embodiment of the present invention. FIG. 2 illustrates a window of a programming tool for a robot application program according to an embodiment of the present invention. FIG. 3 illustrates an example of a task description which can be made on the basis on an XML schema. FIGS. 4 to 7 illustrates tasks in FIG. 2 in detail.

First, referring to FIG. 1, a method of creating programming tools shown in FIG. 2 and supplying them to a user is illustrated using a schematic flowchart. First, operations to be performed by a robot are classified by functions. These operations include speech recognition, speech synthesis, event generation by sensing information, control stream control, multimedia play, e-mail sending, and home network associated information for electronic appliance control. The operations to be performed by the robot are classified by functions in operation S110. Next, behavior of the robot which can constitute the functions is displayed on a display device in a graphical form which allows the behavior to be visually connected together with conditions. More specifically, each of the actions of the robot, including speech recognition, speech synthesis, and motion, and constituting the functions in operation S110, is represented by an action block. A toolbar is constructed to be used for linking the behaviors of the robot, displayed in graphical form, and supplied to a monitor. Accordingly, the user selects each action block and connects the action blocks as shown in FIG. 2 to complete one function. The aforementioned action blocks include a user-defined block which can be reused as a library, a control block for controlling execution including repetition (loop) and condition (if), and a sensor/event block which is used as the condition of the control block when a specific event is generated. When the contents of the user-defined block are changed, the contents of the user-defined block in another related block are concurrently changed. The user-defined block, the control block, and the sensor/event block are displayed as different diagrams, but they are connectable to one another to form one graphical shape in operation S120.

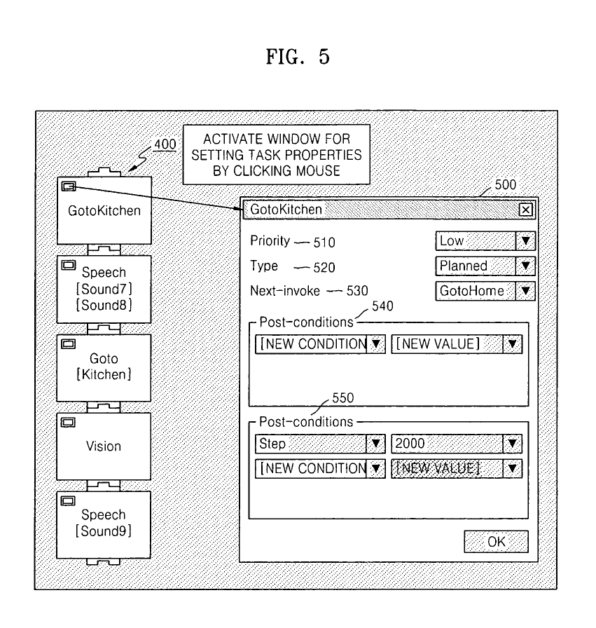

After processing the graphic including the action blocks, the user assembles the displayed action blocks to complete the function. Then, the function is converted into an XML file to become an application program. At this time, an input condition for execution of a task and a completion condition for completion of the task are supplied to the user. That is, the user graphically inputs the selected condition as shown in FIGS. 5 to 7. Output information, which is the execution result of the task, and property information, which defines exceptional situations obstructing the execution of the task, are supplied to the user, and a selected condition is input by the user. Accordingly, the completed function is converted into the XML file in operation S130.

A programming tool for programming a robot application according to an embodiment of the present invention will now be described in detail, with reference to FIGS. 2 to 7. Hereinafter a programming tool 200 is assumed to be the same as the programming device. As described above, the programming tool 200 shown in FIG. 2 is created by the method of supporting robot application programming, and is displayed on the display device of the user. Referring to FIG. 2, the programming tool includes a general tool bar at the top of the window, a selection window 220 for calling each action block, and an action window 220 including a plurality of action blocks for performing a function desired by the user.

The different types of action blocks are distinguished by color and shapes. Several action blocks can be combined. For example, a square may indicate an action including a sub-behavior, an octagon may indicate a minimal unit action, a round roof shape may indicate a loop control, and a wide roof shape may indicate a branching statement such as IF.

Each of the action blocks includes a fold/unfold button and a property dialog button to control its features.

The action that constitutes the action block includes predetermined unit behavior such as MoveTo, Text To Speech (TTS), GoTo, and the like, according to types.

The action blocks include a user-defined block, a control block, and a sensor/event block. The user-defined block can be reused as a library. When the contents of the user-defined block are changed, the contents of the user-defined block in another related block are concurrently changed. The control block for controlling execution including repetition (loop) and condition (if) can be divided into sub-categories as needed by the programmer. The sensor/event block is used as the conditional statement of the control block when a sensing information event is generated.

The action block describes what the robot has to do. However, the task to be performed by the robot is described by using information on when to act, what conditions are required, what happens when the task is completed, and exceptional conditions dependent on the task.

Accordingly, a task editor for representing the action block includes an input (input of each attribute in FIGS. 5 to 7) condition for indicating an execution condition, a completion condition for creating a successful execution result of the task, output information for indicating an execution result, and attribute information for defining an exceptional situation representing the case where the task can not be executed any more.

In addition, the task editor according to an embodiment of the present invention supports forming design patterns of the robot task to reuse the robot task regardless of the service domain of the robot. The design pattern is determined by classifying the designs for solving similar problems by analyzing the design examples for various problems, and generalizing and establishing the most suitable design for each problem type. In the embodiment of the present invention, the robot task can be visually recognized according to the shapes and patterns of the visual blocks.

Therefore, in the robot application service area, the knowledge about the robot task design or the know-how as to the design pattern is well materialized into the problem for each type, and moreover, the knowledge about the solution or the know-how is sufficiently generalized about the same problem type to the pattern type.

An XML schema for defining a task of the robot will now be described. Service XML describes tasks to be distributed to URCSA. At present, in URCSA, only one service XML has to be designated when the system starts, but the service XML is expected to exchange in order to load the service through a network.

<!- -

In URCSA, a service is a bundle of tasks. The task is a bundle of behavior. The service describes attributes of the tasks that it includes. One service includes one or more tasks.

Used in: services

- - >

<! ELEMENT service (servicename, task*)>

<!- -

The name of a service is designated.

Used in: service

- - >

<! ELEMENT service-name (#PCDATA)>

<!- -

The attributes of each task that constitutes the service are designated. The attributes of each task include name, property, and behavior information. Each task includes one or more types of behavior.

Used in: service

- - >

<! ELEMENT task (name, properties, behavior*)>

<!- -

The name of the task is designated.

Used in: task

- - >

<! ELEMENT name (#PCDATA)>

<!- -

The attributes of the task are designated. The attributes of the task include an execution mode, call instruction, priority, an execution type, the task to execute next, and the like. The detailed contents of the attribute information are described in each tag description.

The execution mode indicates an invoke mode, and the execution type indicates whether the program is executed in parallel, single, or planned mode.

Each element that constitutes the properties is changed depending on the attributes to be designated according to an event, a command, and the execution mode of a timer. Timertype, expiration, duration, and interval are used only when the exetype is a timer task.

Used in: task

- - >

<! ELEMENTproperties (exectype, type, command?, priority?, next-invoke?,2 post-condition?, pre-condition?, timertype?, firetime?, duration?, interval?)>

<!- -

The execution mode (invoke mode) of a task is designated. The execution modes of the task are classified into event, command, and timer. The task which is set as an event is performed by using the next-invoke of another task instead of the command of the external system.

Used in: properties

- - >

<! ELEMENT exectype (#PCDATA)>

<!- -

The execution type of the task is designated. The execution type of the task may be parallel, single, or planned.

1) Parallel Task: concurrently executable tasks (tasks which do not include Moveto and Gototo)

Example) Music Play Task, E-mail Send Task, Home Appliance Control Task. etc.

2) Single Task : an exclusively executable task in a system

Example) Follow Person Task etc

3) Planned Task : task to which a path planning operation is applicable

Example) MoveTo Task, GoTo Task etc

Used in: properties

- - >

<! ELEMENT type (#PCDATA)>

<!- -

When the execution mode of the task is designated to a command or event, a command used to call the task is designated. When the execution mode is designated to an event, the command is transmitted to a planner to perform planning.

Used in: properties

- - >

<! ELEMENT command (#PCDATA)>

<!- -

The priority of a task is arbitrarily designated by a user who constructs the task by considering the relation among tasks. When there is no priority, the priority is dynamically designated to the tasks which are set as the planned tasks on the basis of the distance from the planner of URCSA.

Used in: properties

- - >

<! ELEMENT priority (#PCDATA)>

<!- -

A task to be called after the execution of the current task is completed is designated. The next task is executed in an event mode.

Used in: properties

- - >

<! ELEMENT next-invoke (#PCDATA)>

<!- - The condition of a case where the execution of the task is completed and the execution result of the task is success is described. The successful completion of the task is checked by LogicalSensor. The type and the value of LogicalSensor are designated by the user. When the Post Condition is not satisfied, the next task that is set by the Next invoke cannot be performed.

Used in: properties

- - >

<! ELEMENT post-condition (logicalsensor, value)>

<!- -

The type of LogicalSensor, which checks the completion condition of the task, is designated.

Used in: post-condition

- - >

<! ELEMENT logicalsensor (#PCDATA)>

<!- -

The value of LogicalSensor, which checks the completion condition of the task, is designated.

Used in: post-condition

- - >

<! ELEMENT value (#PCDATA)>

<!- -

The condition for checking whether the task can be executed, before execution of the task, is described. The determination of the execution of the task is checked by LogicalSensor similarly to the post-condition. The type and the value of LogicalSensor are designated by the user. When the Pre Condition is not satisfied, the task cannot be performed.

Used in: properties

- - >

<! ELEMENT pre-condition (logicalsensor, value)>

<!- -

The type of LogicalSensor which checks the execution condition of the task is designated.

Used in: pre-condition

- - >

<! ELEMENT logicalsensor (#PCDATA)>

<!- -

The value of LogicalSensor which checks the execution condition is designated.

Used in: pre-condition

- - >

<! ELEMENT value (#PCDATA)>

<!- -

Timertype is designated when the execution mode is Timer. The timertype includes OneshotTimer or PeriodicTimer (refer to FIG. 8).

1) OneshotTimer is a task which is performed once at a predetermined time (absolute time)

2) PeriodicTimer is a task which is repeatedly performed at predetermined time intervals (relative time)

Used in: properties

- - >

<! ELEMENT timertype (#PCDATA)>

<!- -

Firetime is a value that is set when the execution mode of the task is Timer. When the Timer Task is OneshotTimer, the firetime indicates a period from a registration time to when the timer is fired.

Used in: properties

- - >

<! ELEMENT firetime (#PCDATA)>

<!- -

Duration is a value that is set when the execution mode of the task is Timer. When the timertype is set as PeriodicTimer, the duration indicates the period until the timer is first fired.

Used in: properties

- - >

<! ELEMENT duration (#PCDATA)>

<!- -

Interval is a value that is set when the execution mode of the task is Timer. When the timertype is set as PeriodicTimer, the interval indicates the period after which the Timer Task is fired.

Used in: properties

- - >

<! ELEMENT interval (#PCDATA)>

<!- -

Information on the behaviors which constitute the task is described. The Behaviors are classified into system Behaviors which are supplied from URCSA and user Behaviors which are prepared by the user.

Used in: task

- - >

<! ELEMENT behaviors (#PCDATA)>

<!- -

Unit behaviors which constitute the task are described.

Used in: behaviors

- - >

<! ELEMENT behavior (sequence, type, owner, defined-class-name?, normal-content?, abnormal_content?, post-condition?, goal?)>

<!- -

An execution sequence of the unit behaviors which constitute the task is described.

Used in: behavior

- - >

<! ELEMENT sequence (#PCDATA)>

<!- -

The type of each Behavior is designated. The behavior types supported by the system are MoveTo, Goto, Speech, Vision, and homegateway. The behavior prepared by the user may be executed.

Used in: behavior

- - >

<! ELEMENT type (#PCDATA)>

<!- -

It is determined whether the behavior is supported by the system or prepared by the user. The type of the behavior may be user or system.

Used in: behavior

- - >

<! ELEMENT owner (#PCDATA)>

<!- -

When the user is the owner, the name of the behavior class prepared by the user is designated. The class name has to be designated as a full name including a package.

Used in: behavior

- - >

<! ELEMENT defined-class-name (#PCDATA)>

<!- -

Normal-content is a value used for Speech behavior. When there is no Next Invoke Task, the normal-content is a value to be played by SpeechBehavior.

Used in: behavior

- - >

<! ELEMENT normal-content (#PCDATA)>

<!- -

Abnormal-content is a value used for Speech behavior. When a Next Invoke Task exists, the abnormal-content is a value to be played by SpeechBehavior.

Used in: behavior

- - >

<! ELEMENT abnormal-content (#PCDATA)>

<!- -

Goal is a value used for GotoBehavior and MoveTo Behavior. The goal designates a goal position of Goto or Moveto. The goal indicates a symbol value defined in Map.xml.

Used in: behavior

- - >

<! ELEMENT goal (#PCDATA)

FIG. 3 illustrates an example of a task description which can be prepared on the basis of an XML schema and the name of the task is gotokitchen. As known from the tag corresponding to properties, when the robot user commands the robot to go to the kitchen through speech, the robot recognizes the speech, for example, and the gotokitchen task is performed. The gotokitchen task includes three types of behavior and has an execution sequence of that behavior. Specifically, the gotokitchen task includes Text-To-Speech behavior having sound7 and sound8 files, goto behavior including a destination that is a kitchen, and Text-To-Speech behavior having sound9, and has the execution sequence of that behavior.

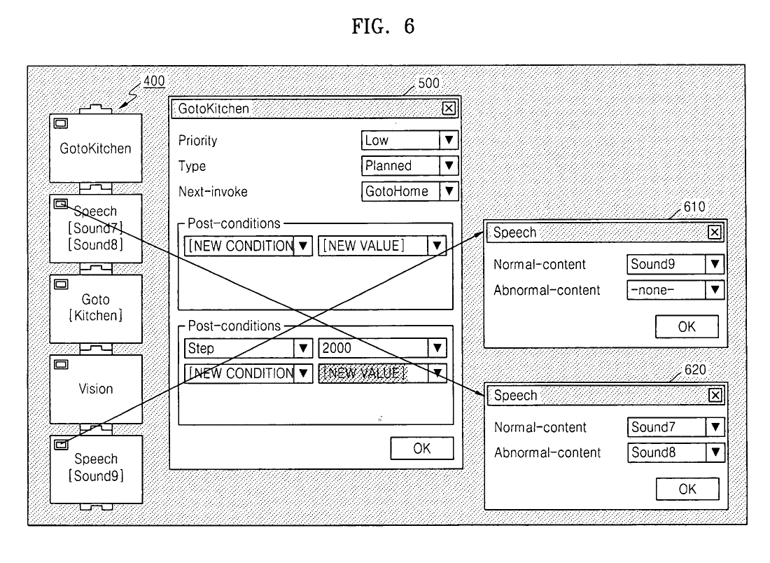

FIG. 4 illustrates that the gotokitchen task 410 is represented by using the visual programming environment shown in FIG. 2. FIG. 5 illustrates a popup window 400 that is opened when the left top icon 210 of the visual block which indicates the go to kitchen task, is clicked by a mouse. The popup window 400 defines properties of the gotokitchen task. FIG. 6 illustrates a popup window that is opened when the left top icon of the visual block which indicates a Text-To-Speech action is clicked by the mouse. The popup window defines properties of the Text-To-Speech action. An action block 420 for indicating the Text-To-Speech behavior including sound7 and sound8 files, an action block 430 for indicating goto behavior including a destination that is a kitchen, an action block 440 for indicating behavior of obtaining an image, and an action block 450 for indicating the Text-To-Speech behavior including a sound9 file, are connected to one another so as to be sequentially executed.

Action blocks for indicating a task, behavior, and a control block IF or LOOP may have different colors in order to be easily distinguished from one other.

FIG. 5 illustrates an example in which conditions of an action block are input. In the structure shown in FIG. 4, when the left top icon of the action block for indicating the gotokitchen task is clicked, a window 500 for setting properties is activated. In this example, priority 510, type 520, next-invoke 530, post-conditions 540 and 550 can be set by the user.

FIG. 6 illustrates an example in which conditions of the action blocks are input as shown in FIG. 5, except that the conditions are those of the Text-To-Speech action. When the speech[sound7][sound8] block is clicked, a window 620 pops up to determine the execution sequence of normal and abnormal cases. When the speech[sound9] is clicked, a window 610 pops up. Sound9 is executed in the normal case, and no sound (“none”) is executed in the abnormal case.

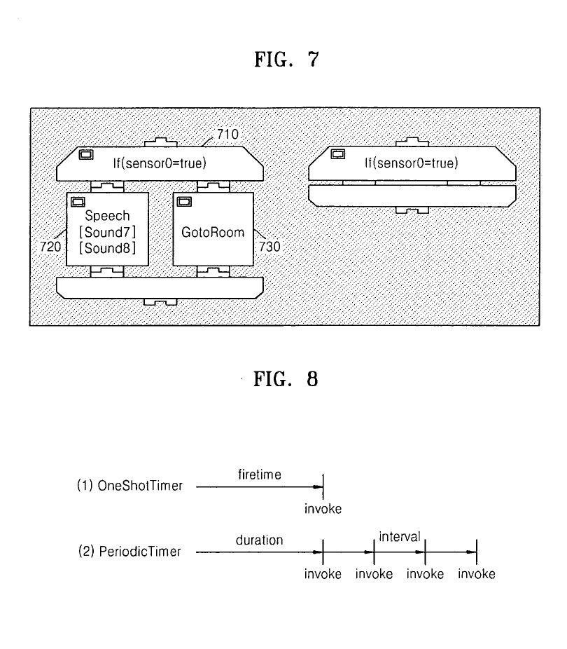

FIG. 7 illustrates IF action block 710 of the control blocks. In FIG. 7, when the result of sensor0==true, which is a conditional statement, is true, the left action block, which is Speech 720, is executed. Alternatively, when the result is false, the right action block that is goToroom 730 is executed.

Accordingly, the robot task developer only defines the properties of each action block and combines the visually represented action blocks shown FIGS. 2 to 7 with one another without directly preparing the XML file in a text form shown in FIG. 3. In the visual programming environment shown in FIG. 2, the XML file, which describes the service including the aforementioned gotokitchen task, is automatically created from the visualized task expression shown in FIGS. 2 to 7.

As described above, according to the method of supporting robot application programming and the programming tool for the same, various robot applications can be intuitively, easily and speedily developed by simply using the tool boxes of the graphical programming tools without directly inputting code in text form.

The programming tool in the visual programming environment is a function block obtained by visualizing the library of essential components such as control methods for sensors and motors used by the robot, human-robot interaction, autonomous traveling, and speech/image recognition.

The robot application developer can develop the robot application in the visual programming environment by dragging and dropping the tool box using the mouse, like assembling lego blocks and defining necessary properties using the function of the tool box.

In addition, the user can easily modify and update the robot application, thereby reducing the cost and time needed for preparing the robot application programs.

Only the defined motion of the robot can be performed in the past. In the present invention, the accurate motion of the robot desired by the contents developer can be embodied by designating various types of parameter properties according to the types of the robot actions.

The method of supporting robot application programming according to an embodiment of the present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. A method of supporting robot application programming in which behaviors that constitutes operations to be performed by a robot are assembled in a programming tool for programming an application program for the operations to be performed by the robot, the method comprising:
(a) classifying the operations to be performed by the robot by functions of the robot;
(b) displaying the behavior of the robot which can constitute one of the functions on a display device in a graphical form with block shapes that can be connected one another visually with a plurality of conditions; and
(c) converting a set of the blocks into an XML file, when the function of the robot is constructed as a robot task by the set of blocks in the graphical form.

2. The method of claim 1, wherein (b) comprises:
(b1) representing each of all the behaviors to be performed by the robot, which includes speech recognition, speech synthesis, and motion, and constitutes the function, as an action block; and
(b2) constructing a toolbar to connect the action blocks displayed in the graphical form to one another.

3. The method of claim 2, wherein in (b1), the action block includes:
(b11) a user-defined block which can be reused as a library and of which contents are concurrently modified in other blocks related to the user-defined block when contents of the user-defined block are modified;
(b12) a control block which controls execution including repetition (loop) and condition (if); and
(b13) a sensor/event block which is used as the condition of the control block when a specific event is generated.

4. The method of claim 3, wherein the user-defined block, the control block, and the sensor/event blocks have different shapes and are connectable to one another to form one graphical shape.

5. The method of claim 1, wherein the (c) comprises:
(c1) supplying an input condition for execution of a task and a completion condition for completion of a task and receiving a selected condition; and
(c2) supplying output information that is the execution result of the task and property information that defines an exceptional situation which prevents the execution of the task, and receiving selected condition.

6. A programming tool for a robot application program, the programming tool comprising:
an action window which displays an action block obtained by visualizing one or more behaviors to be performed by a robot;
a selection window in which the behavior of the action block is displayed and a selected behavior is input into the action block; and
a toolbar window which includes shortcuts related to a pallet menu that can open or close, storing/opening, uploading to the robot, and executing operations and supplies tools for completing the execution of the action block.

7. The programming tool of claim 6, wherein the behaviors are distinguished by using colors and shapes of the action blocks.

8. The programming tool of claim 7, wherein in the shapes of the action blocks, a square indicates a behavior including a sub-behavior, an octagon indicates a minimal unit behavior, a round roof shape indicates a loop control, and a wide roof shape indicates a branching behavior.

9. The programming tool of claim 7, wherein each of the action blocks includes a fold/unfold button which folds or unfolds the action block and a property dialog button in which the properties of the action can be designated.

10. The programming tool of claim 6, wherein the action block includes:
a user-defined block which can be reused as a library and of which contents are concurrently modified in other blocks related to the user-defined block when contents of the user-defined block are modified;
a control block which controls execution including repetition (loop) and condition (if); and
a sensor/event block which is used as the condition of the control block when a specific event is generated.

11. A computer-readable recording medium having embodied thereon a computer program for executing a method of supporting robot application programming in which behaviors that constitutes operations to be performed by a robot are assembled in a programming tool for programming an application program for the operations to be performed by the robot, the method comprising:
(a) classifying the operations to be performed by the robot by functions of the robot;
(b) displaying the behaviors of the robot, which can constitute one of the functions on a display device in a graphical form with block shapes that can be connected one another visually with a plurality of conditions; and
(c) converting a set of the blocks into an XML file, when the function of the robot is constructed as a robot task by the set of blocks in the graphical form.
